(19) United States
(12) Patent Application Publication
(10) Pub. No.: US 2011/0140629 A1
(43) Pub. Date: Jun. 16, 2011

(54) POWER SUPPLY FOR LIGHTING LUMINARY FOR FIXING MAXIMUM AND MINIMUM ILLUMINATION

(76) Inventors: Guang-Ming LEI, Taoyuan City (TW); Yu-Hsien Cheng, Taoyuan City (TW)

(21) Appl. No.: 12/637,143

(22) Filed: Dec. 14, 2009

(51) Int. Cl. H05B 41/16

(52) U.S. Cl. 315/287

(57) ABSTRACT

A power supply for a lighting luminary for fixing maximum and minimum illumination is applied to a TRIAC dimmer and at least one lighting luminary. The power supply includes a dimming circuit for fixing maximum and minimum illumination, an input voltage detector, a feedback circuit, a DC-to-DC converter, and a rectifier. The dimming circuit for fixing maximum and minimum illumination outputs a reference voltage. More particularly, the feedback circuit controls the lighting luminary be operated at maximum illumination when a conduction angle of the TRIAC dimmer is excessive according to the reference voltage. Similarly, the feedback circuit controls the lighting luminary to be operated at minimum illumination when a conduction angle of the TRIAC dimmer is excessively small.

### BACKGROUND OF THE INVENTION

1. Field of the Invention

The present invention relates to a power supply for a lighting luminary, and more particularly to a power supply for a lighting luminary for fixing maximum and minimum illumination.

2. Description of Prior Art

Reference is made to FIG. 7 which is a block diagram of a prior art power supply for a lighting luminary. The prior art power supply for a lighting luminary 100A is applied to an AC power 10A, a TRIAC dimmer 20A, and at least lighting luminary 50A. The TRIAC dimmer 20A is electrically connected to the AC power 10A. The power supply 100A is electrically connected to the TRIAC dimmer 20A and the lighting luminary 50A.

The power supply 100A includes a full-wave rectifier 30A, a DC-to-DC converter 40A, an input voltage detector 60A, a feedback circuit 70A, and a dimming signal generator 80A. The full-wave rectifier 30A is electrically connected to the TRIAC dimmer 20A, the DC-to-DC converter 40A, and the input voltage detector 60A. The feedback circuit 70A is electrically connected to the DC-to-DC converter 40A, the dimming signal generator 80A, and the lighting luminary 50A. The lighting luminary 50A is electrically connected to the DC-to-DC converter 40A and the feedback circuit 70A. The dimming signal generator 80A is electrically connected to the feedback circuit 70A and the input voltage detector 60A.

The input voltage detector 60A generates a DC voltage V1, which is processed by the dimming signal generator 80A to generate a dimming signal S1. The dimming signal S1 is proportional to the conduction angle of the TRIAC dimmer 20A. Namely, the dimming signal S1 is larger when the conduction angle is larger; the dimming signal S1 is smaller when the conduction angle is smaller. In addition, the conduction angles of the TRIAC dimmers 20A may be different because the TRIAC dimmers 20A are manufactured by different manufacturers. Accordingly, the different dimming signals S1 are likely to influence maximum and minimum illumination of the lighting luminary 50A.

More particularly, an AC voltage waveform graph outputted from the TRIAC dimmer 20A as shown in FIG. 6.

### SUMMARY OF THE INVENTION

In order to solve the above-mentioned problems, the present invention provides a power supply for a lighting luminary for fixing maximum and minimum illumination.

In order to achieve the objectives mentioned above, the power supply for a lighting luminary for fixing maximum and minimum illumination is applied to a TRIAC dimmer and at least one lighting luminary. The power supply for a lighting luminary for fixing maximum and minimum illumination includes a dimming circuit for fixing maximum and minimum illumination, an input voltage detector, a feedback circuit, a DC-to-DC converter, and a rectifier. The input voltage detector is electrically connected to the dimming circuit. The feedback circuit is electrically connected to the dimming circuit and the lighting luminary. The DC-to-DC converter is electrically connected to the input voltage detector, the feedback circuit, and the lighting luminary. Also, the rectifier is electrically connected to the input voltage detector, the DC-to-DC converter, and the TRIAC dimmer. More particularly, the dimming circuit receives a DC voltage, which is outputted from the input voltage detector, and outputs a reference voltage to the feedback circuit. The feedback circuit receives the reference voltage to control the lighting luminary operate at maximum illumination when a conduction angle of the TRIAC dimmer is excessive and to control the lighting luminary operate at minimum illumination when a conduction angle of the TRIAC dimmer is excessively small.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of a power supply for a lighting luminary for fixing maximum and minimum illumination according to the present invention;

FIG. 2 is a circuit diagram of an embodiment of a first part of a dimming circuit for fixing maximum and minimum illumination;

FIG. 3 is a circuit diagram of an embodiment of a second part of the dimming circuit for fixing maximum and minimum illumination;

FIG. 4 is a triangle waveform graph inputted into a non-inverting input end of the first operational amplifier;

FIG. 5 is a view showing mathematical expressions of calculating the minimum voltage and the maximum voltage of the triangle waveform;

FIG. 6 is a voltage waveform graph outputted from a prior art TRIAC dimmer;

FIG. 7 is a block diagram of a prior art power supply for a lighting luminary;

FIG. 8 is a graph showing relationship between a conduction angle and an output current.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

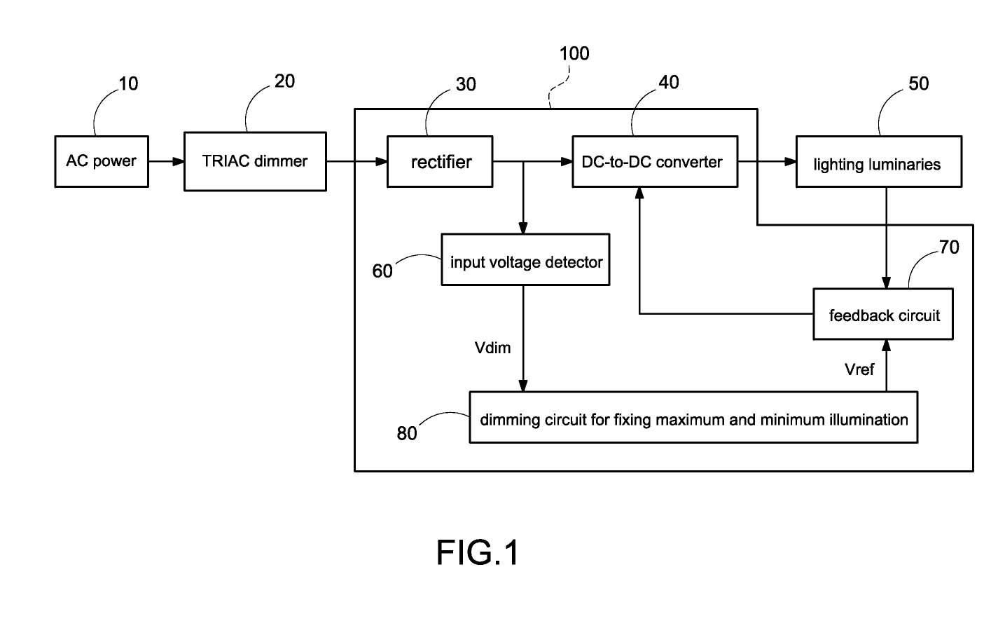

Reference will now be made to the drawing figures to describe the present invention in detail. Reference is made to FIG. 1 which is a block diagram of a power supply for a lighting luminary for fixing maximum and minimum illumination according to the present invention. The power supply for a lighting luminary for fixing maximum and minimum illumination 100 is applied to an AC power 10, a TRIAC dimmer 20, and at least one lighting luminary 50. The TRIAC dimmer 20 is electrically connected to the AC power 10. The power supply for a lighting luminary for fixing maximum and minimum illumination 100 is electrically connected to the TRIAC dimmer 20 and the lighting luminary 50.

The power supply for a lighting luminary for fixing maximum and minimum illumination 100 includes a dimming circuit for fixing maximum and minimum illumination 80, a feedback circuit 70, an input voltage detector 60, a DC-to-DC converter 40, and a rectifier 30. The rectifier 30 is electrically connected to the input voltage detector 60, the DC-to-DC converter 40, and the TRIAC dimmer 20. The dimming circuit for fixing maximum and minimum illumination 80 is electrically connected to the input voltage detector 60 and the feedback circuit 70. The feedback circuit 70 is electrically connected to the dimming circuit 80, the DC-to-DC converter 40, and the lighting luminary 50. The lighting luminary 50 is electrically connected to the DC-to-DC converter 40 and the feedback circuit 70.

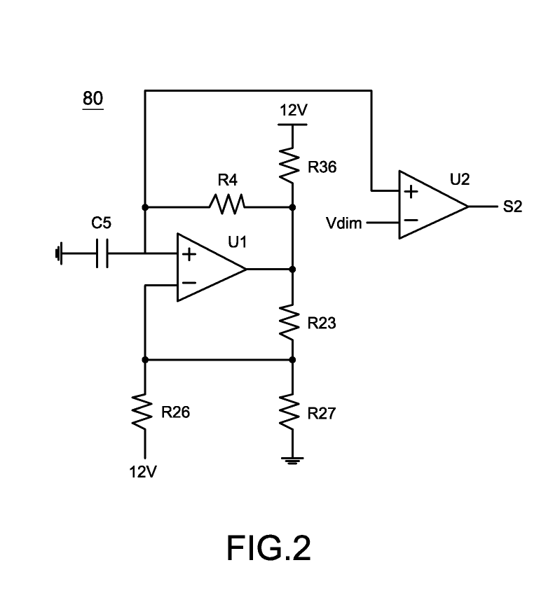

Reference is made to FIG. 2 which is a circuit diagram of an embodiment of a first part of a dimming circuit for fixing maximum and minimum illumination. The dimming circuit for fixing maximum and minimum illumination 80 includes a first operational amplifier U1, a second operational amplifier U2, a first resistor R36, a second resistor R4, a third resistor R23, a fourth resistor R26, a fifth resistor R27, and a first capacitor C5.

A non-inverting input end of the first operational amplifier U1 is electrically connected to a non-inverting input end of the second operational amplifier U2. An inverting input end of the second operational amplifier U2 is electrically connected to the input voltage detector 60. One end of the first resistor R36 is electrically connected to a 12-volt voltage, and the other end of the first resistor R36 is electrically connected to an output end of the first operational amplifier U1. One end of the second resistor R4 is electrically connected to the output end of the first operational amplifier U1, and the other end of the second resistor R4 is electrically connected to the non-inverting input end of the first operational amplifier U1. One end of the third resistor R23 is electrically connected to the output end of the first operational amplifier U1, and the other end of the third resistor R23 is electrically connected an inverting input end of the first operational amplifier U1. One end of the fourth resistor R26 is electrically connected to the 12-volt voltage, and the other end of the fourth resistor R26 is electrically connected to the inverting input end of the first operational amplifier U1. One end of the fifth resistor R27 is grounded, and the other end of the fifth resistor R27 is electrically connected to the inverting input end of the first operational amplifier U1. One end of the first capacitor C5 is grounded, and the other end of the first capacitor C5 is electrically connected to the non-inverting input end of the first operational amplifier U1.

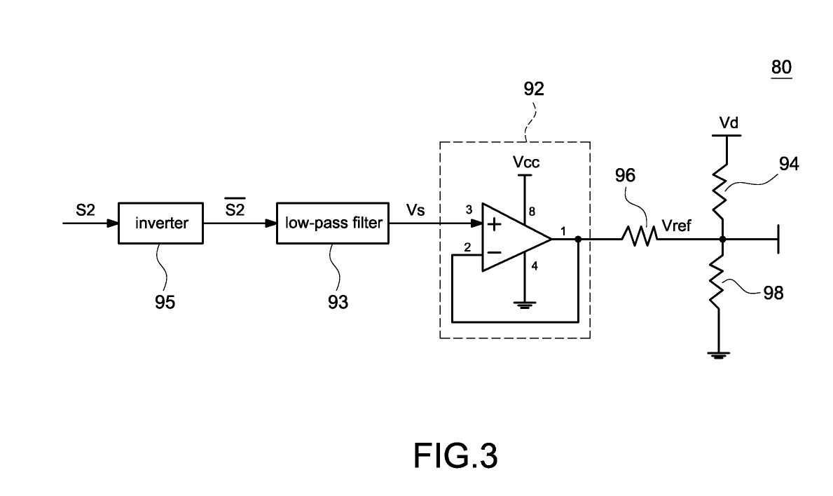

Reference is made to FIG. 3 which is a circuit diagram of an embodiment of a second part of the dimming circuit for fixing maximum and minimum illumination. The dimming circuit for fixing maximum and minimum illumination 80 further includes a low-pass filter 93, an inverter 95, a voltage follower 92, a sixth resistor 94, a seventh resistor 96, and a eighth resistor 98. One end of the sixth resistor 94 is electrically connected to the feedback circuit 70 and the seventh resistor 96, and the other end of the sixth resistor 94 is electrically connected to a compensation voltage Vd. One end of the seventh resistor 96 is electrically connected to the output end of the voltage follower 92, and the other end of the seventh resistor 96 is electrically connected to the feedback circuit 70, the sixth resistor 94, and the eighth resistor 98. One end of the eighth resistor 98 is electrically connected to the feedback circuit 70, the sixth resistor 94, and the seventh resistor 96, and the other end of the eighth resistor 98 is grounded. A non-inverting input end of the voltage follower 92 is electrically connected to the low-pass filter 93. The inverter 95 is electrically connected to the output end of the second operational amplifier 92 and the low-pass filter 93. The voltage follower 92 is further electrically connected between a supply voltage Vcc and a ground.

The operation procedure of the power supply for a lighting luminary for fixing maximum and minimum illumination will be described as follows, and further to refer to FIG. 1, FIG. 2, and FIG. 3.

The key concept of the power supply for a lighting luminary for fixing maximum and minimum illumination is as follows: The dimming circuit for fixing maximum and minimum illumination 80 outputs a reference voltage Vref. The DC-to-DC converter 40 and the feedback circuit 70 control the lighting luminary 50 to be operated at maximum illumination when a conduction angle of the TRIAC dimmer 20 is excessive when the feedback circuit 70 receives the reference voltage Vref. In addition, the DC-to-DC converter 40 and the feedback circuit 70 control the lighting luminary 50 to be operated at minimum illumination when a conduction angle of the TRIAC dimmer 20 is excessively small when the feedback circuit 70 receives the reference voltage Vref. The detailed description will be made hereinafter.

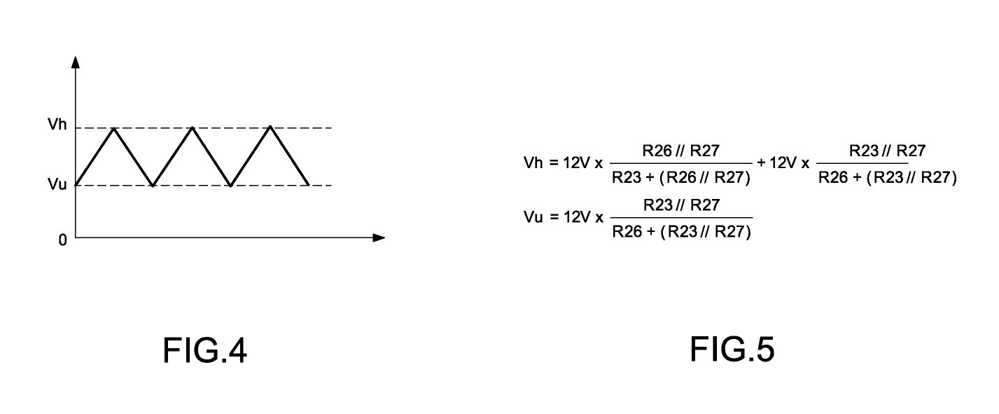

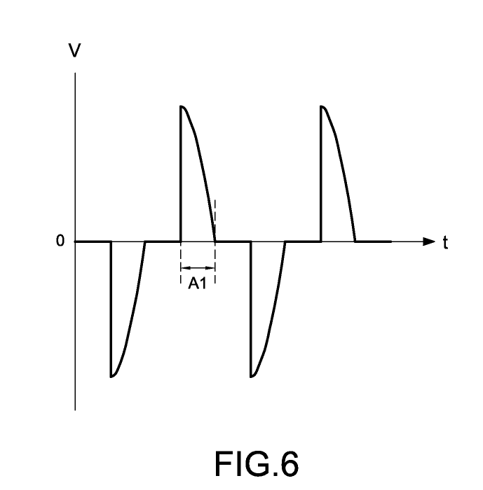

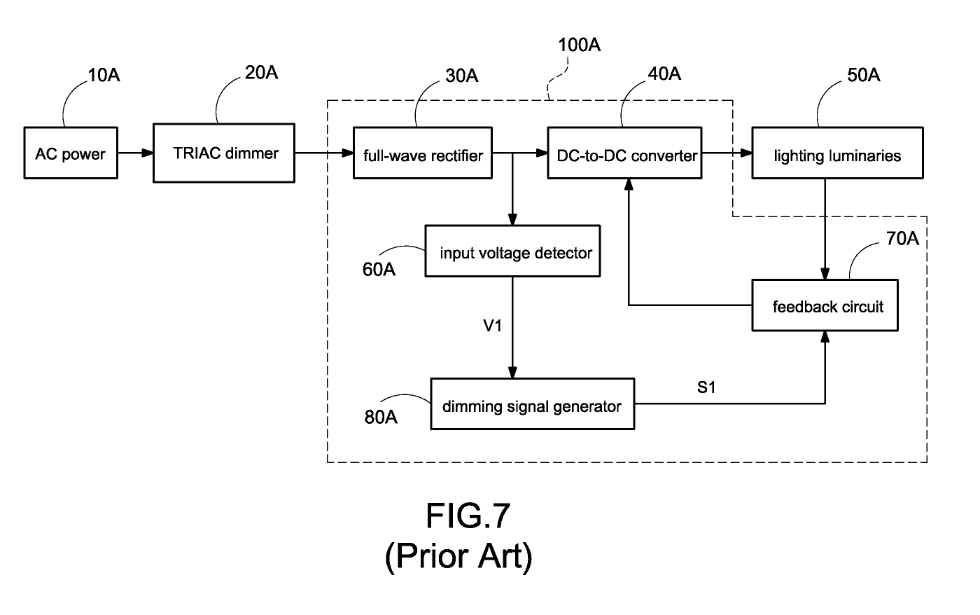

The configuration of the first operational amplifier U1 is a hysteresis comparator. The non-inverting input end of the first operational amplifier U1 can be inputted a triangle waveform as shown in FIG. 4. Also, the triangle waveform is inputted to the non-inverting input end of the second operational amplifier U2. A DC voltage, which is outputted from the input voltage detector 60, is electrically connected to the inverting input end of the second operational amplifier U2. The triangle waveform is compared to the DC voltage Vdim through the second operational amplifier U2 to output a PWM dimming signal S2. The PWM dimming signal S2 is sent to the inverter 95 to generate a reverse PWM dimming signal S̅2̅. The reverse PWM dimming signal S̅2̅ is sent to the low-pass filter 93 to generate a dimming voltage Vs and the dimming voltage Vs is sent to the non-inverting input end of the voltage follower 92.

The minimum voltage Vu and the maximum voltage Vh of the DC voltage Vdim are corresponding to the maximum duty (100%) and the minimum duty (0%) of the PWM dimming signal S2, respectively. Also, the minimum voltage Vu and the maximum voltage Vh of the DC voltage Vdim are corresponding to the minimum output current and the maximum output current. For example, the DC voltage is 2 volts when the conduction angle is 90 degrees, and the DC voltage is 4 volts when the conduction angle is 120 degrees. If the conduction angle of the TRIAC dimmer 20 is set between 90 degrees to 120 degrees, the minimum voltage Vu and the maximum voltage Vh of the DC voltage Vdim will be set to 2 volts and 4 volts. More particularly, the minimum voltage Vu and the maximum voltage Vh can be determined (as shown in FIG. 5) through the third resistor R23, the fourth resistor R24, and the fifth resistor R27.

The initial-boosting reference voltage Vref can be provided by dividing the compensation voltage Vd through the sixth resistor 94, the seventh resistor 96, and the eighth resistor 98 (as shown in FIG. 3). The main feature of the voltage follower 92 is that output voltage of the voltage follower 92 is simply equal to non-inverting input voltage thereof. The output voltage of the voltage follower 92 will be held at a maximum output voltage VOH when the non-inverting input voltage is more than the maximum output voltage VOH of the voltage follower 92. Similarly, he output voltage of the voltage follower 92 will be held at a minimum output voltage VOL when the non-inverting input voltage is less than the minimum output voltage VOL of the voltage follower 92. Namely, the output voltage of the voltage follower 92 is between minimum output voltage VOL and the maximum output voltage VOH.

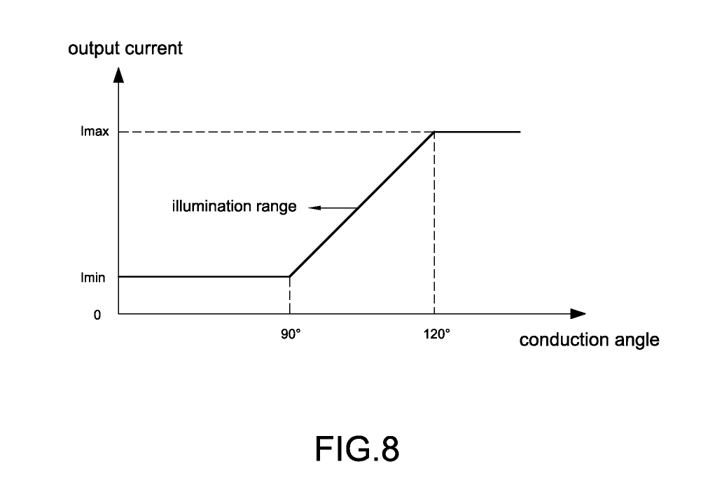

The reference voltage Vref is sent to the feedback circuit 70 by the dimming circuit for fixing maximum and minimum illumination 80 to determine the current flowed to the lighting luminary 50. The output voltage of the voltage follower 92 will be held at the maximum output voltage VOH to keep the lighting luminary operate at maximum illumination (even though the conduction angle is excessively large) when the dimming voltage Vs is more than the maximum output voltage VOH. Similarly, the output voltage of the voltage follower 92 will be held at the minimum output voltage VOL to keep the lighting luminary operate at minimum illumination (even though the conduction angle is excessively small) when the dimming voltage Vs is less than the minimum output voltage VOL. More particularly, the relationship between the conduction angle and the output current is shown in FIG. 8.

In addition, the rectifier 30 has to be a half-wave rectifier to keep the lighting luminary operate at minimum illumination but an full-wave rectifier will turn off when the conduction angle is excessively small.

Hence, the minimum voltage Vu and the maximum voltage Vh of the DC voltage Vdim can be are determined when the minimum conduction angle and the maximum conduction angle have been set. Afterward, the values of the third resistor R23, the fourth resistor R26, and the fifth resistor R27 can be calculated according to the minimum voltage Vu and the maximum voltage Vh and the mathematical expressions shown in FIG. 5. Finally, the voltage follower 92 is added to the resistor network to output full-duty rated current (from 1%-rated current to 100%-rated current) according to the set range of the conduction angle. Accordingly, it can overcome variations of the minimum illumination and the maximum illumination because the TRIAC dimmers 20A are manufactured by different manufacturers.

In conclusion, the present invention has following advantages:

1. Initially, the minimum conduction angle and the maximum conduction angle can be set. The lighting luminary operates at minimum illumination when the conduction angle of the TRIAC dimmer is less than the set minimum conduction angle; and the lighting luminary operates at maximum illumination when the conduction angle of the TRIAC dimmer is more than the set maximum angle.

2. The lighting luminary can be operated at full-duty illumination range (namely, from 1% to 100% illumination) by adjusting values of the resistor network to increase flexibility of illumination.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power supply for a lighting luminary for fixing maximum and minimum illumination is applied to a TRIAC dimmer and at least one lighting luminary, the power supply comprising:
a dimming circuit for fixing maximum and minimum illumination;
an input voltage detector electrically connected to the dimming circuit;
a feedback circuit electrically connected to the dimming circuit and the lighting luminary;
a DC-to-DC converter electrically connected to the input voltage detector, the feedback circuit, and the lighting luminary; and
a rectifier electrically connected to the input voltage detector, the DC-to-DC converter, and the TRIAC dimmer;
wherein the dimming circuit receives a DC voltage, which is outputted from the input voltage detector, and outputs a reference voltage to the feedback circuit; the feedback circuit receives the reference voltage to keep the lighting luminary operate at maximum illumination when a conduction angle of the TRIAC dimmer is excessive and to keep the lighting luminary operate at minimum illumination when a conduction angle of the TRIAC dimmer is excessively small.

2. The power supply for a lighting luminary for fixing maximum and minimum illumination in claim 1, wherein the dimming circuit for fixing maximum and minimum illumination comprises a PWM dimming signal generator and a low-pass filter; the PWM dimming signal generator is electrically connected to the low-pass filter; the PWM dimming signal generator generates a PWM dimming signal after receiving the DC voltage outputted from the input voltage detector; the PWM dimming signal is sent to the low-pass filter to generate the reference voltage; and the reference voltage is sent to the feedback circuit.

3. The power supply for a lighting luminary for fixing maximum and minimum illumination in claim 2, wherein the dimming circuit further comprises a first operational amplifier and a second operational amplifier; a non-inverting input end of the first operational amplifier is connected to a non-inverting input end of the second operational amplifier, and an inverting input end of the second operational amplifier is connected to the input voltage detector.

4. The power supply for a lighting luminary for fixing maximum and minimum illumination in claim 3, wherein the dimming circuit further comprises:
a voltage follower, a non-inverting of the voltage follower is electrically connected to the output end of the second operational amplifier; and
an inverter, the inverter is electrically connected to the output end of the second operational amplifier and the low-pass filter;
wherein the non-inverting input end of the first operational amplifier U1 can be inputted a triangle waveform; the triangle waveform is compared to the DC voltage through the second operational amplifier to output a PWM dimming signal; the PWM dimming signal is sent to the low-pass filter to generate a dimming voltage; the dimming voltage is sent to the non-inverting input end of the voltage follower to generate the reference voltage; and the reference voltage is sent to the feedback circuit.

5. The power supply for a lighting luminary for fixing maximum and minimum illumination in claim 4, wherein the dimming circuit further comprises:
a first resistor, one end of the first resistor is electrically connected to a 12-volt voltage, and the other end of the first resistor is electrically connected to an output end of the first operational amplifier;
a second resistor, one end of the second resistor is electrically connected to the output end of the first operational amplifier, and the other end of the second resistor is electrically connected to the non-inverting input end of the first operational amplifier;
a third resistor, one end of the third resistor is electrically connected to the output end of the first operational amplifier, and the other end of the third resistor is electrically connected to the inverting input end of the first operational amplifier;
a fourth resistor, one end of the fourth resistor is electrically connected to the 12-volt voltage, and the other end of the fourth resistor is electrically connected to the inverting input end of the first operational amplifier;
a fifth resistor, one end of the fifth resistor is grounded, and the other end of the fifth resistor is electrically connected to the inverting input end of the first operational amplifier; and
a first capacitor, one end of the first capacitor is grounded, and the other end f the first capacitor is electrically connected to the non-inverting input end of the first operational amplifier.

6. The power supply for a lighting luminary for fixing maximum and minimum illumination in claim 5, wherein the dimming circuit further comprises:
a sixth resistor, one end of the sixth resistor is electrically connected to the feedback circuit, and the other end of the sixth resistor is electrically connected to a compensation voltage;
a seventh resistor, one end of the seventh resistor is electrically connected to the output end of the voltage follower, and the other end of the seventh resistor is electrically connected to the feedback circuit, and the sixth resistor;
a eighth resistor, one end of the eighth resistor is electrically connected to the feedback circuit, the sixth resistor, and the seventh resistor, and the other end of the eighth resistor is grounded.
